(19) United States
(12) Patent Application Publication
(10) Pub. No.: US 2007/0281654 A1
(43) Pub. Date: Dec. 6, 2007

(54) Method and apparatus for selecting antenna for ranging detection in orthogonal frequency division multiple access system

(76) Inventor: Joonsang Choi, Seoul (KR)

Correspondence Address: FENWICK & WEST LLP, SILICON VALLEY CENTER, 801 CALIFORNIA STREET, MOUNTAIN VIEW, CA, 94041, US

(21) Appl. No.: 11/444,063

(22) Filed: May 30, 2006

(51) Int. Cl. H04B 1/00; H04B 1/06; H04M 1/00

(52) U.S. Cl. 455/277.1; 455/562.1; 455/63.4

(57) ABSTRACT

A method of selecting an antenna for ranging detection in an orthogonal frequency division multiple access system, the method including: receiving at least one ranging symbol from the antenna; and determining whether to select the antenna, by correlation computing the received ranging symbol in a time domain.

### BACKGROUND OF THE INVENTION

1. Field of the Invention

The present invention relates to an antenna selection method and apparatus for effectively performing ranging detection in an orthogonal frequency division multiple access (OFDMA) mobile communication system.

2. Description of the Related Art

A mobile communication system based on a theory of electromagnetic wave propagation via a wireless channel transmits and receives a signal by using antennas installed at a transmitting end and a receiving end, respectively. Particularly, in the case of the receiving end, since all processes of receiving a wireless signal, obtaining a symbol, and extracting data start at the antenna, entire system performance largely depends on antenna performance.

Accordingly, the receiving end may include a plurality of antennas and may have a function of selecting a certain antenna for transmitting and receiving a signal with the transmitting end. Particularly, when communicating with a plurality of transmitting ends, it is very important to select an antenna for providing an optimal communication channel with respective transmitting ends. Since the mobile communication system employs a bidirectional communication scheme in which a base station and a terminal both transmit and receive signals, a transmitting/receiving end, represented by a base station and a terminal, has to select an antenna. Generally, a process of selecting the antenna is performed by the base station equipped with a plurality of antennas.

The process of selecting the antenna is very important for initial connection establishment between a mobile communication terminal (hereinafter, referred to as “terminal”) and a base station. The term, “ranging” is used for indicating a process of initial connection establishment in an OFDM/OFDMA mobile communication system. Since the ranging as a process of a terminal's access to a base station is embodied via a process of detecting a ranging signal, the ranging may be called as a ranging detection. In the present specification, “ranging” or “ranging detection” may include a timing synchronization process performed when signals having a different propagation delay are received from a plurality of terminals, and may be understood as a concept indicating a series of processes for maintaining a connection quality of wireless communication between a base station and a terminal in the OFDM/OFDMA mobile communication system. Also, an effective use of the ranging process is an important indicator of a terminal-support capability of the base station.

However, when an antenna for ranging detection is not selected prior to ranging detection, the ranging detection has to be performed with respect to all antennas or antenna paths. Accordingly, hardware and software resources used for the ranging detection is increased in proportion to a number of antennas, and ranging detection functionality may be decreased if there is restriction on the hardware and software resources. Accordingly, to reduce complexity of a system for the ranging detection and to effectively use resources, antenna selection must be performed prior to an initiation of ranging detection.

A process of selecting an antenna for connection establishment between a terminal and a base station in a conventional code division multiple access (CDMA) mobile communication system is generally based on a method of using a pilot symbol.

FIG. 1 is a flowchart illustrating a conventional antenna selection method using a pilot symbol. Referring to FIG. 1, a conventional antenna selection method includes operations of receiving a pilot symbol transmitted from a transmitting end or a terminal (S101), calculating a sample average value and a sample energy of the pilot symbol, respectively (S102 and S103), calculating a variance value of the pilot symbol by using the average value and the energy obtained in operations S102 and S103 (S104), calculating a signal to interference and noise ratio (SINR) by using the variance value and the average value (S105), and selecting an antenna having a maximum SINR obtained in operation S105.

The SINR with respect to the received pilot symbol is calculated as shown in Equation 1. \tilde{p}p* is obtained by multiplying a received pilot symbol \tilde{p} and a known pilot symbol sequence p*, and a sample average value mₛₐₘₚₗₑ and a sample energy Eₛₐₘₚₗₑ of \tilde{p}p* are calculated. A variance σ² of \tilde{p}p* may be obtained from the calculated sample average value and sample energy, and an SINR may be obtained from a ratio of the sample average value and sample energy. Equation 1 shows a process of calculating the SINR.

$${m}_{sample} = \frac{1}{{N}_{pilot}} {\sum }_{i = 0}^{{N}_{pilot} - 1} \tilde{p} ( i ) {p}^{*} ( i ) , \\ {E}_{sample} = \frac{1}{{N}_{pilot}} {\sum }_{i = 0}^{{N}_{pilot} - 1} {[ \tilde{p} ( i ) {p}^{*} ( i ) ]}^{2} , \\ {σ}^{2} = {E}_{sample} - {m}_{sample}^{2} , \\ {SINR}_{sample} = \frac{{m}_{sample}^{2}}{{σ}^{2}} = \frac{{m}_{sample}^{2}}{{E}_{sample}^{2} - {m}_{sample}^{2}} \qquad Equation ( 1 )$$

For reference, in Equation 1, Nₚᵢₗₒₜ indicates a number of signal samples forming the pilot symbol and SINRₛₐₘₚₗₑ indicates a sample SINR with respect to the pilot symbol. An antenna corresponding to a maximum value from obtained values of an SINR is used for initial connection establishment.

FIG. 2 is a block diagram illustrating an internal configuration of an apparatus embodying a conventional method of selecting an antenna by using an SINR calculated using a pilot symbol. FIG. 2 illustrates a configuration of an apparatus for obtaining a calculation result according to Equation 1. Referring to FIG. 2, a multiplication result 203, obtained by multiplying a received pilot symbol 201 and a complex conjugate 202 of a previously stored pilot sequence, is inputted to an average value calculation unit 211 and an energy calculation unit 213. The average value calculation unit 211 calculates a sample average value 204 with respect to the inputted multiplication result 203. The apparatus of FIG. 2 obtains a variance value 207 by subtracting a square of the sample average value 204, obtained by a square operator 212, from the sample energy 206 which is a calculation result of an energy calculation unit 213. An SINR 208, obtained as a ratio of the square of the sample average value 205 and the variance value 207, is inputted to an antenna selection unit 214 and is used for selecting an antenna.

FIG. 3 is a block diagram schematically illustrating a configuration of a conventional antenna selection apparatus performing the method illustrated in FIG. 1 with respect to a plurality of antennas. Referring to FIG. 3, the conventional antenna selection apparatus selects an antenna based on an SINR value calculated with respect to each of the plurality of antennas.

To describe a selection process on the basis of a first antenna 301 in detail, a pilot symbol signal, received via the first antenna 301 is converted into a frequency domain signal via a fast Fourier transform (FFT) unit 311, and an SINR value with respect to the pilot symbol signal received from the first antenna 301 is calculated by an SINR calculation unit 321 using the frequency domain signal. The described process is repeated with respect to a second antenna 302 and a third antenna 303, and an antenna corresponding to a maximum SINR value from the SINR values of the plurality of antennas is selected by an antenna selection unit 330.

In brief, in the conventional antenna selection method, an antenna receiving a signal having a maximal strength is selected by using an SINR value of a pilot symbol received from a terminal.

However, the conventional antenna selection method using the pilot symbol has several problems when applied to the OFDM/OFDMA mobile communication system.

For example, a ranging signal supported by an international standard IEEE802.16d/e with respect to OFDM/OFDMA communication systems does not include pilot symbol information. Accordingly, the conventional method of calculating an SINR value by using a pilot symbol cannot be applied as is.

In addition, when an SINR value is calculated based on a frequency domain signal, a same number of FFT units are required as a total number of antennas. When an amount of frequency domain calculations, that requires a large amount of computational resources and memory resources, is increased in proportion to the total number of antennas, system resources may be very inefficiently used.

As another problem, the conventional method of selecting an antenna by comparing strength of received signals cannot provide information with respect to a channel quality in a multi-path fading channel environment. In a multi-path fading channel environment in which electric waves received via different paths are reflected a number of times by various objects, resulting in irregular variations in amplitude and phase of the electric wave at a receiver side, an interfering signal may be stronger than a desired user signal. Accordingly, when only signal strengths are compared without a signal quality index, a channel via which the desired signal is transmitted cannot be distinguished from a channel in which interference occurs, causing a selection of a suboptimal antenna and thereby deteriorating performance of the system. Particularly, the described problem may occur excessively in a ranging interval where signals are received from a plurality of terminals at the same time.

Accordingly, a more suitable antenna selection method for a multi-path fading channel environment is required. Accordingly, in the present invention, a new method associated with selecting an antenna, which is simple and scalable, is provided.

### SUMMARY OF THE INVENTION

An aspect of the present invention also provides an antenna selection method by using a time domain signal of a received ranging symbol, thereby providing a simple and scalable antenna selection method.

An aspect of the present invention provides a method of selecting an antenna based on reliability information reflecting quality of a signal received from an antenna, thereby selecting an optimal antenna for a multi-path fading channel environment.

An aspect of the present invention also provides an antenna selection method in which a pilot symbol is not used in computing a reliability value, thereby selecting an optimal antenna in a process compatible with IEEE802.16d/e and OFDM/OFDMA standards.

An aspect of the present invention also provides an antenna selection method in which a cyclic prefix interval including a signal of the same pattern and a guard interval from a received ranging symbol are referred to, thereby selecting an optimal antenna by sufficiently reflecting a channel feature.

An aspect of the present invention also provides an antenna selection method in which a cyclic prefix interval and a guard interval of any one ranging symbol received after an initially received ranging symbol from a plurality of ranging symbols, thereby maintaining a precise reliability value calculation in a multi-path fading channel environment.

An aspect of the present invention also provides a detailed internal configuration of an antenna selection apparatus including a reliability calculation unit using a cyclic prefix interval and a guard interval of a time domain ranging symbol.

An aspect of the present invention also provides a detailed configuration of a base station system including an apparatus of selecting an antenna based on a reliability value calculated using a cyclic prefix interval and a guard interval of a time domain ranging symbol.

According to an aspect of the present invention, there is provided a method of selecting an antenna for ranging detection in an orthogonal frequency division multiple access system, the method including: receiving at least one ranging symbol from the antenna; and determining whether to select the antenna, by correlating the received ranging symbol in a time domain.

According to another aspect of the present invention, there is provided a ranging detection method including: calculating a reliability value with respect to each of a plurality of antennas by correlating a respective ranging symbol received from the plurality of antennas in a time domain, selecting an antenna based on the calculated reliability values; and detecting ranging based on a calculation of a time domain or a frequency domain with respect to a ranging symbol received from the antenna selected via the described operation.

According to another aspect of the present invention, there is provided an apparatus for selecting an antenna for ranging detection in an orthogonal frequency division multiple access system, the apparatus including: a ranging symbol storage unit storing a ranging symbol received in a time domain from each of a plurality of antennas; a sampling unit sampling a first sample signal and a second sample signal from the stored ranging symbol; a correlation value calculation unit calculating a correlation value between the first sample signal and the second sample signal; a deviation value calculation unit calculating a deviation value between the first sample signal and the second sample signal; a reliability calculation unit calculating a reliability value of the each of the plurality of antennas by using the correlation value and the deviation value calculated for the each of the plurality of antennas; and an antenna selection unit selecting the antenna corresponding to a maximum reliability value from the calculated reliability values.

According to another aspect of the present invention, there is provided a mobile communication base station system including: a plurality of antennas for receiving a ranging symbol from a mobile communication terminal; and an antenna selection apparatus selecting at least one antenna from the plurality of antennas based on correlating of the ranging symbol received in a time domain from each of the plurality of antennas.

For reference, “ranging symbol” mentioned in the present specification may be interpreted as a series of subcarrier data transmitted from a terminal, for a ranging detection.

Also, the ranging symbol indicates a signal received in a time domain via a ranging channel. Accordingly, the terms “ranging symbol” and “ranging signal” which appear in the specification indicate a time domain signal.

And the ranging channel is composed of one or more groups of six adjacent subchannels, where the groups are defined starting from the first subchannel. Optionally, ranging channel can be composed of eight adjacent subchannels using the symbol structure. The indices of the subchannels that compose the ranging channel are specified in the UL-MAP message. Users are allowed to collide on this ranging channel. To effect a ranging transmission, each user randomly chooses one ranging code from a bank of specified binary codes. These codes are then BPSK modulated onto the subcarriers in the ranging channel, one bit per subcarrier.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a flowchart illustrating a conventional antenna selection method using a pilot symbol;

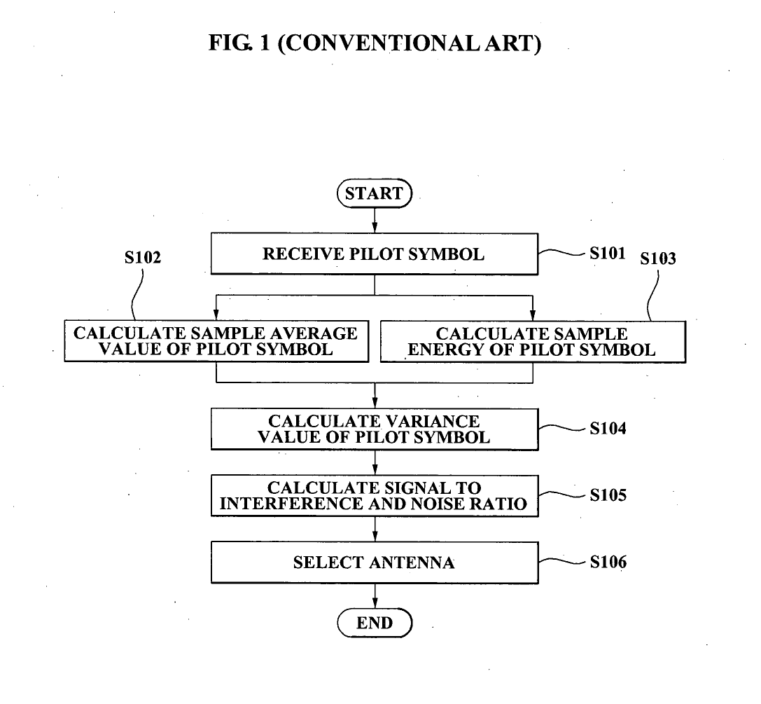

FIG. 2 is a block diagram illustrating an internal configuration of an apparatus embodying a conventional method of selecting an antenna by using a signal to interference and noise ratio (SINR) calculated using a pilot symbol;

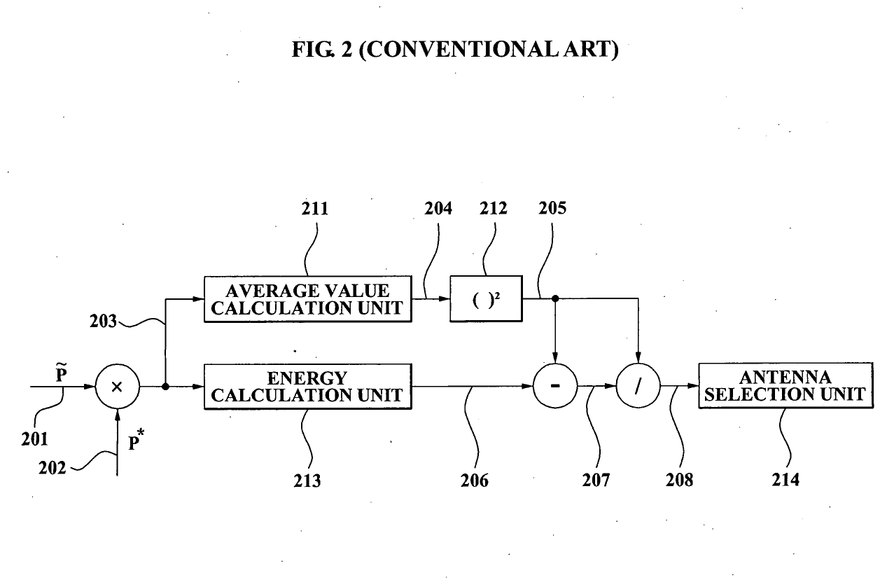

FIG. 3 is a block diagram schematically illustrating a configuration of a conventional antenna selection apparatus performing the method illustrated in FIG. 1 with respect to a plurality of antennas;

FIG. 4 is a flowchart illustrating an antenna selection method according to an embodiment of the present invention;

FIG. 5 is a flowchart illustrating the operation of calculating a reliability value in detail, included in the antenna selection method according to an embodiment of the present invention;

FIG. 6 is a diagram illustrating a configuration of a ranging symbol used in the antenna selection method according to an embodiment of the present invention;

FIG. 7 is a diagram illustrating a ranging symbol used in the antenna selection method and a configuration of the ranging symbol according to an embodiment of the present invention;

FIG. 8 is a diagram illustrating a time domain ranging symbol signal received in the operation of receiving the ranging symbol, included in the antenna selection method according to an embodiment of the present invention;

FIG. 9 is a diagram illustrating a ranging symbol used in the antenna selection method according to an embodiment of the present invention, from time domain signals of the ranging symbol shown in FIG. 8 and a first sample signal and a second sample signal sampled from the ranging symbol;

FIG. 10 is a flowchart illustrating an antenna selection method according to another embodiment of the present invention;

FIG. 11 is a block diagram illustrating an internal configuration of an antenna selection apparatus according to an embodiment of the present invention;

FIG. 12 is a block diagram illustrating internal configurations of a correlation value calculation unit and a deviation value calculation unit of FIG. 1; and

FIG. 13 is a block diagram illustrating the operations of the antenna selection apparatus according to an embodiment of the present invention, with respect to a plurality of antennas.

### DETAILED DESCRIPTION OF THE INVENTION

Reference will now be made in detail to the embodiments of the present invention, examples of which are illustrated in the accompanying drawings, wherein like reference numerals refer to the like elements throughout. The embodiments are described below to explain the present invention by referring to the figures.

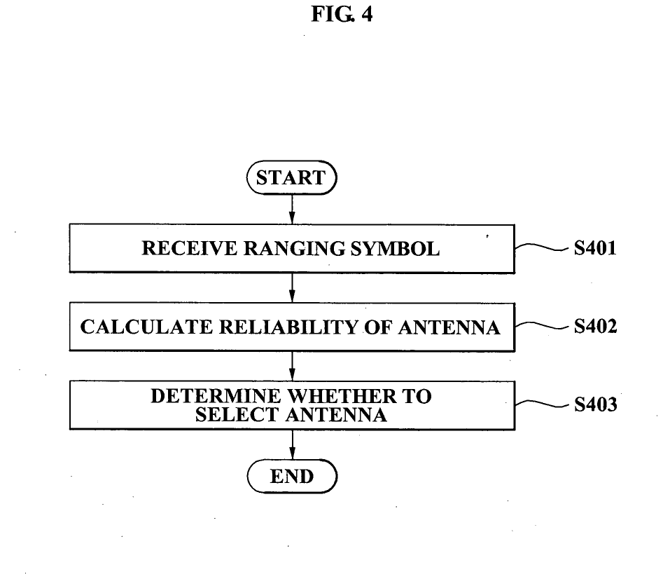

FIG. 4 is a flowchart illustrating an antenna selection method according to an embodiment of the present invention. Hereinafter, each operation will be described with reference to FIG. 4. For reference, in FIG. 4, whether to select an individual antenna is described. However, “antenna selection” mentioned in following description includes not only determining whether to use an individual antenna but also selecting one or more antennas from a plurality of antennas.

In operation S401, at least one ranging symbol is received from each of a plurality of antennas. The ranging symbol received in operation S401 is expressed as a time domain signal. As described above, in the antenna selection method according to an embodiment of the present invention, the time domain signal of the ranging symbol is used. When applying the antenna selection method using a time domain calculation, a method and a configuration of an apparatus for selecting an antenna become simplified, thereby efficiently using system resources and enabling scalability.

In operation S402, a reliability value of an antenna from the plurality of antennas is calculated by correlating the time domain signal of the received ranging symbol.

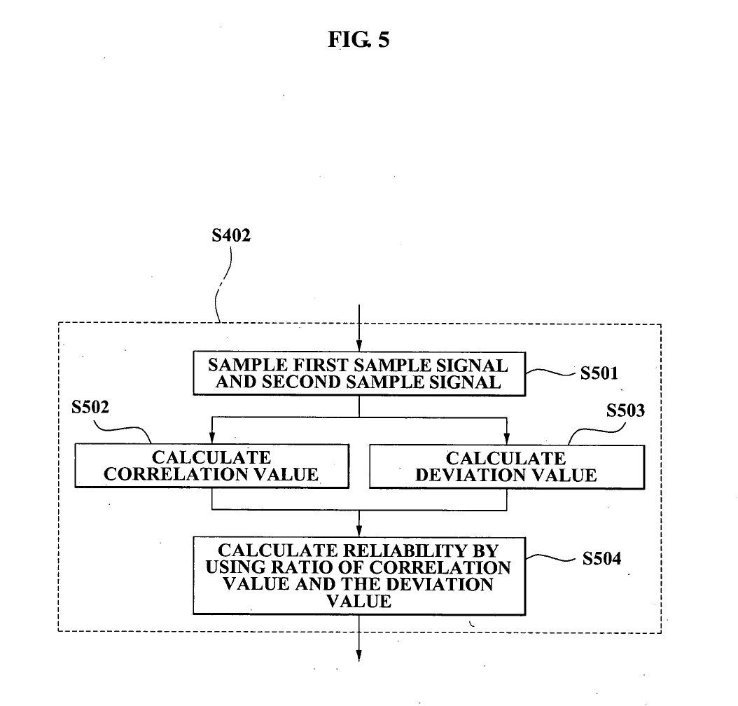

FIG. 5 is a flowchart illustrating operation S402 of calculating a reliability value in detail, included in the operations shown in FIG. 4. Hereinafter, referring to FIG. 5, a method of calculating a reliability value will be described for each operation.

In operation S501, a first sample signal and a second sample signal are sampled from the ranging symbol of the ranging signal received in a time domain from the antenna. According to an embodiment of the present invention, lengths of the first sample signal and the second sample signal sampled in operation S501 may be determined based on a length of a cyclic prefix of the received ranging symbol. The first sample signal may include a cyclic prefix interval of the ranging symbol, and the second sample signal may include a guard interval of the ranging symbol. The described configuration is caused by a repetition property in a time domain of an OFDM/OFDMA symbol.

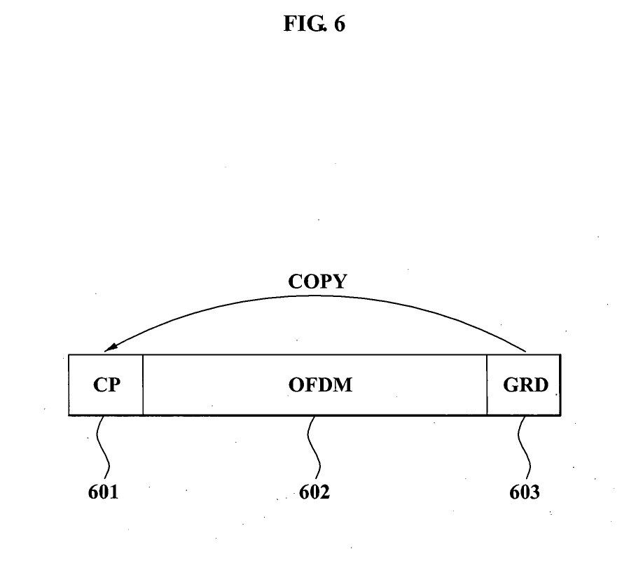

FIG. 6 is a diagram illustrating a configuration of the ranging symbol used in the antenna selection method according to an embodiment of the present invention. As shown in FIG. 6, one OFDM/OFDMA symbol includes a valid symbol duration consisting of 602 and 603 including a valid signal and a cyclic prefix interval 601 made by copying and inserting the guard interval 603, disposed at an end portion of the valid symbol duration consisting of 602 and 603, in front of the valid symbol duration consisting of 602 and 603. The guard interval 603 and the prefix interval 601 prevent loss of orthogonality between subcarriers.

Accordingly, signals of the cyclic prefix interval 601 and the guard interval 603 may have exactly matching patterns when interference, delay spread, or distortion of the signal is not considered. Also, even when considering a certain effect caused by noise, the signals of the two intervals may be estimated to maintain a similar pattern. In the present embodiment, performance of the antenna is determined by comparing signal patterns of the cyclic prefix interval 601 and the guard interval 603 with each other. To compare the signals of the two intervals, in the antenna selection method according to the present embodiment, the first sample signal and the second sample signal are sampled from the received ranging symbol in a time domain.

According to an embodiment of the present invention, the first sample signal may be sampled from the cyclic prefix interval 601 of the ranging symbol and the second sample signal may be sampled from the guard interval 603.

As described above, the lengths of the first sample signal and the second sample signal may be determined based on a length of the cyclic prefix interval (601) of the time domain ranging symbol signal. Hereinafter, the content of the present invention will be described in a case in which the lengths of the first sample signal and the second sample signal are identical with the length of the cyclic prefix interval. However, the technical scope of the present invention is not limited by the embodiments to be described. For example, it is well known to those skilled in the art that the lengths of the two sample signals may be determined to be shorter than the length of the cyclic prefix interval or to be longer than the length of the cyclic prefix interval with respect to a certain ranging symbol.

As described above, the ranging symbol that becomes an object of sampling of the first sample signal and the second sample signal, may be transmitted a number of times. For reference, in IEEE802.16d/e standards, a case of transmitting twice and a case of transmitting four times are specified.

In an OFDM/OFDMA communication system, a cyclic prefix interval has a problem that a signal may be distorted due to a multi-path fading channel occurring between symbols. Particularly, in the case of an initially received ranging symbol, it is difficult to measure an effect caused by a multi-path fading channel. In addition, since a signal is distorted due to another symbol disposed just prior to the ranging symbol, it may be difficult to use an entire cyclic prefix interval.

On the other hand, in the case of a ranging symbol received after an initially received ranging symbol, when a delay spread interval of a multi-path fading channel is smaller than a designated cyclic prefix interval, a repetition feature of the second ranging symbol is guaranteed. Therefore, to increase precision of a reliability value calculation, the reliability value may be calculated by sampling the first sample signal and the second sample signal from a time domain signal of the ranging symbol received after an initially received ranging symbol.

In addition, the initially received ranging symbol may be applied to the present invention.

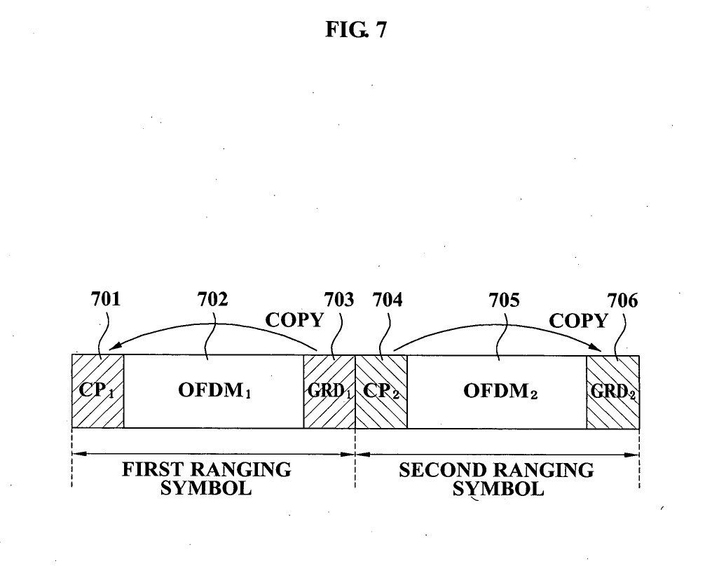

FIGS. 7 through 9 illustrate examples of a ranging symbol selection process.

FIG. 7 is a diagram illustrating a ranging symbol used in the antenna selection method and a configuration of the ranging symbol according to an embodiment of the present invention. In a cyclic prefix interval 701 of a first ranging symbol shown in FIG. 7, as described above, a signal may be distorted due to interference with an immediately preceding signal. However, since a second ranging symbol received immediately following the first ranging symbol is identical with the first ranging symbol in a time domain and a frequency domain, inter-symbol interference (ISI) does not largely occur. Namely, a cyclic prefix interval 704 of the second ranging symbol includes a signal similar to a guard interval 706 because the signal is relatively undistorted.

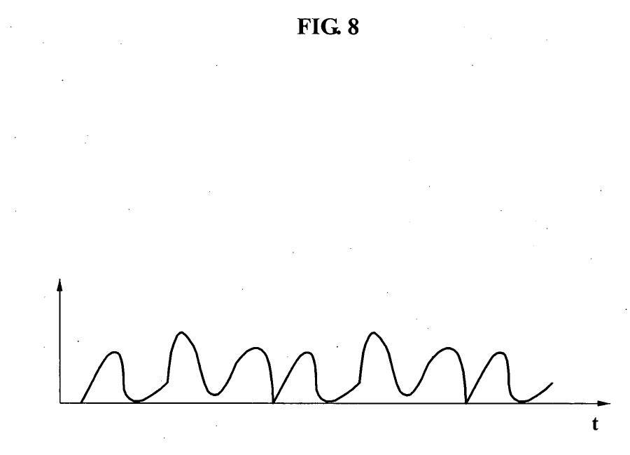

FIG. 8 is a diagram illustrating a time domain ranging symbol signal received in the operation of receiving the ranging symbol, included in the antenna selection method according to an embodiment of the present invention. FIG. 8 illustrates an example of an actual waveform of the time domain signal of the ranging symbol, with respect to a time axis. A plurality of ranging symbols received sequentially has a similar signal pattern as shown in FIG. 8.

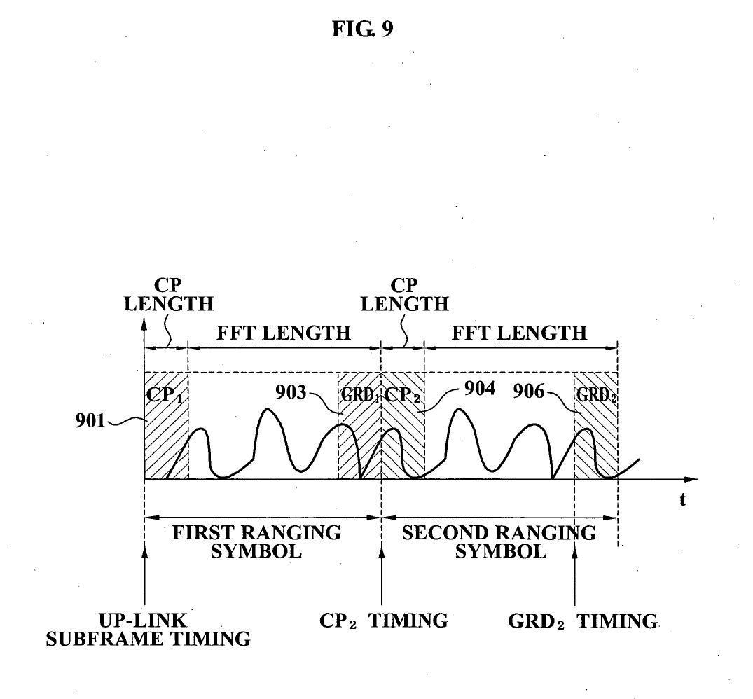

FIG. 9 is a diagram illustrating a ranging symbol used in the antenna selection method according to an embodiment of the present invention from the time domain ranging symbol signal shown in FIG. 8 and a first sample signal and a second sample signal sampled from the ranging symbol.

A starting position of an OFDM/OFDMA symbol including a ranging symbol is identified based on frame timing. FIG. 9 illustrates configurations of a first ranging symbol whose starting position is identified by a timing of an up-link sub-frame transmitted from a respective terminal to a base station and a second ranging symbol received after the first ranging symbol. As shown in FIG. 9, in a cyclic prefix interval 901 of the first ranging symbol, a pattern of a signal is not identical with a guard interval 903 of the same ranging symbol. Namely, the pattern of the signal of the cyclic prefix interval (901) is distorted due to another symbol received immediately prior to the first ranging symbol. On the other hand, a cyclic prefix interval 904 of the second ranging symbol has a signal pattern similar to a guard interval 906 of the same symbol. This is because the described inter-symbols interference does not largely occur since the same pattern is sequentially transmitted. Accordingly, to increase precision of antenna selection, a reliability value may be calculated by using a ranging symbol received after an initially received ranging symbol.

In addition, the initially received ranging symbol may be applied to the present invention in spite of this problem.

On the other hand, in operation S502 of FIG. 5, a correlation value is obtained by correlating the first sample signal and the second sample signal sampled from a certain ranging symbol, in a correlation interval of a predetermined length.

Also, in operation S503, a deviation value of the first sample signal and the second sample signal is calculated in the correlation interval. Operations S502 and S503 may be sequentially or simultaneously performed.

Calculating the correlation value and the deviation value performed in operations S502 and S503 may be according to following methods. According to one method, the correlation value is calculated by cumulatively adding a complex conjugate of each sample of the first sample signal multiplied by a corresponding sample of the second sample signal, or a cumulative addition of a complex conjugate of each sample of the second sample signal multiplied by a sample of the first sample signal may be employed.

The deviation value calculated by the operation S503 may include various type of values indicating a difference level of the first sample signal and the second sample signal, such as a standard deviation value or a variance value. As an example, the deviation value may be calculated by cumulatively adding a square of an absolute value of a difference between samples of the first sample signal and the second sample signal. The cumulative addition for the correlation value and the deviation value calculation is performed during the correlation interval of the predetermined length. The predetermined length may be identical or associated with the lengths of the first sample signal and the second sample signal. Namely, the length of the correlation interval may also be determined based on a length of the cyclic prefix interval of the time domain signal of the received ranging symbol.

The calculated correlation value and the deviation value between the first sample signal and the second sample signal are used for calculating the reliability value of the antenna in operation S504. In detail, the reliability value is calculated by a ratio of the correlation value and the deviation value. As the pattern of the first sample signal is similar to the pattern of the second sample signal, the correlation value is increased and the deviation value is decreased. Since the reliability value of the antenna receiving the ranging symbol is determined to be large when the time domain received ranging symbol signal is less distorted, the reliability value may be defined to be in proportion to the correlation value and in inverse proportion to the deviation value.

The described method of calculating the reliability value may be shown as Equation 2.

$${Reliability}_{ant k} = \frac{\frac{1}{L} {\sum }_{i = 0}^{L - 1} \vert {r}_{1} ( i ) \cdot {r}_{2}^{*} ( i ) \vert}{\frac{1}{L} {{\sum }_{i = 0}}^{L - 1} {\vert {r}_{1} ( i ) - {r}_{2} ( i ) \vert}^{2}} \qquad Equation ( 2 )$$

Reliability_{ant k} indicates a reliability value with respect to a k-th antenna, L indicates a length of a correlation, r₁(i) indicates a first sample signal, and r₂(i) indicates a second sample signal. For reference, a numerator of Equation 2 is corresponding to the correlation value between the first sample signal and the second sample signal, and a denominator of Equation 2 is corresponding to the deviation value between the first sample signal and the second sample signal. As described above, the reliability value of the antenna is obtained by a ratio of the correlation value and the deviation value between the first sample signal and the second sample signal.

For reference, a division of the correlation length L common in both the numerator and the denominator of Equation 2 is shown only for easily understanding the correlation value and the deviation value but may not be used in an actual embodiment. As is well-known, to embody a division operation, more software and/or hardware resources are required than for other operations, and much time is consumed for the operation. Accordingly, excluding a particular case, for example, there is a great restriction on a range of numerical values that are calculated by a cumulative adder used for embodying the method of calculating the reliability value, therefore, the division operation may be not included in the operation of calculating the correlation value and the deviation value.

Hitherto, operation S402 of calculating the reliability value by using the time domain ranging symbol signal has been described. Referring to FIG. 4, in operation S403, that is a last operation of the antenna selection method, whether to select the antenna based on the reliability value calculated in operation S402 is determined.

According to an aspect of the present invention, since whether to select an antenna is determined based on a new reference such as the reliability value calculated by using a time domain signal pattern of a ranging symbol, an antenna may be optimally selected in a multi-path fading channel environment in which interference and delay of a signal and a distortion of the signal caused by the interference and delay occur in various patterns.

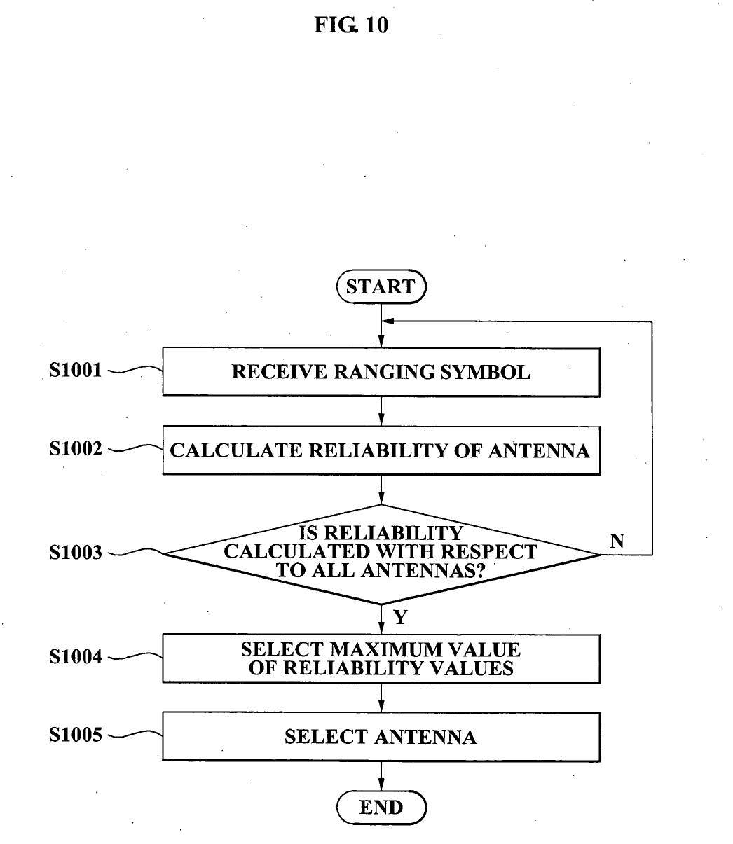

FIG. 10 is a flowchart illustrating an antenna selection method according to another embodiment of the present invention.

As shown in FIG. 10, in operation S1001, at least one ranging symbol is received from a respective antenna. As described in the previous embodiments, time domain signals sampled from a certain ranging symbol of the at least one ranging symbol received from the respective antenna are used for calculating a reliability value that becomes a reference for antenna selection.

In operation S1002, the reliability value is calculated by using the time domain signal of the received ranging symbol, and the reliability value calculation method described with reference to FIG. 5 is applied as is.

In the case of a plurality of antennas, in operation S1003, operations S1001 and S1002 are repeatedly performed with respect to each of the plurality of antennas.

For reference, in operation S1003, calculating the reliability values with respect to each of the plurality of antennas may be sequentially performed or may be simultaneously performed by a plurality of apparatuses.

In operation S1004, a maximum reliability value of the reliability values calculated with respect to each of the plurality of antennas is selected, and an antenna corresponding to the maximum reliability value is selected as an optimal antenna.

The reliability value calculated with respect to the each of the plurality of antennas may be used for antenna selection using a calculated maximum reliability value as in the described embodiment, or may be selected by determining whether to select the antenna based on a predetermined threshold value. In the latter case, at least one antenna may be selected, and a plurality of the selected antennas is used for a preliminary purpose, or for an intermediate antenna selection result when layering the antenna selection process because a total number of antennas is huge.

According to another embodiment of the present invention, strength of the time domain signal of the ranging symbol may be further referred to in addition to using the reliability value calculated as described above, for selecting the antenna. As described above, the accuracy of the antenna selection may be improved when using a complex reference based on various pieces of information. For reference, “strength” of a signal, mentioned in the present specification, indicates an index for amplitude of a wireless signal propagated via a wireless channel, an electrical power or energy of the signal, where a quality index of a wireless signal is not considered. A unit for the strength includes a milliwatt (mW), a decibel milliwatt (dBm), a received signal strength indication (RSSI), and other various units used for indicating power or energy of a signal.

The strength of the received ranging symbol additionally used in determining whether to select the antenna may include an SINR value used in a conventional antenna selection method.

The described antenna selection method is for selecting an antenna performing ranging detection. Accordingly, the technical scope of the present invention is applied to a ranging detection method of an OFDM/OFDMA system, as it is. A ranging detection method according to an embodiment of the present invention includes the operations of calculating a reliability value with respect to each of a plurality of antennas by correlating a respective ranging symbol received from the plurality of antennas, selecting an antenna based on the calculated reliability value, and detecting the ranging based on a calculation in a time domain, with respect to a ranging symbol received from the selected antenna.

In the operation of detecting the ranging, performed by the selected antenna, a ranging signal may be detected based on the calculation in the time domain. Therefore, when performing the ranging detection operation in the time domain, an advantage of the present invention is clearly shown. Namely, in this case, in the present invention, waste of hardware and software resources for conversion into a frequency domain signal may be prevented, for detection of the ranging signal by using the antenna selected in the frequency domain.

As described above, the ranging detection method according to the present embodiment increases scalability of an entire system including an antenna selection apparatus and a ranging detection apparatus, by selecting an antenna based on a calculation in a time domain.

The antenna selection method according to the present invention may be embodied as a program instruction capable of being executed via various computer units and may be recorded in a computer-readable recording medium. The computer-readable medium may include a program instruction, a data file, and a data structure, separately or cooperatively. The program instructions and the media may be those specially designed and constructed for the purposes of the present invention, or they may be of the kind well-known and available to those skilled in the art of computer software arts. Examples of the computer-readable media include magnetic media (e.g., hard disks, floppy disks, and magnetic tapes), optical media (e;g., CD-ROMs or DVD), magneto-optical media (e.g., floptical disks), and hardware devices (e.g., ROMs, RAMs, or flash memories, etc.) that are specially configured to store and perform program instructions. The media may also be transmission media such as optical or metallic lines, wave guides, etc. including a carrier wave transmitting signals specifying the program instructions, data structures, etc. Examples of the program instructions include both machine code, such as that produced by a compiler, and files containing high-level language codes that may be executed by the computer using an interpreter. The hardware elements above may be configured to act as one or more software modules for implementing the operations of this invention.

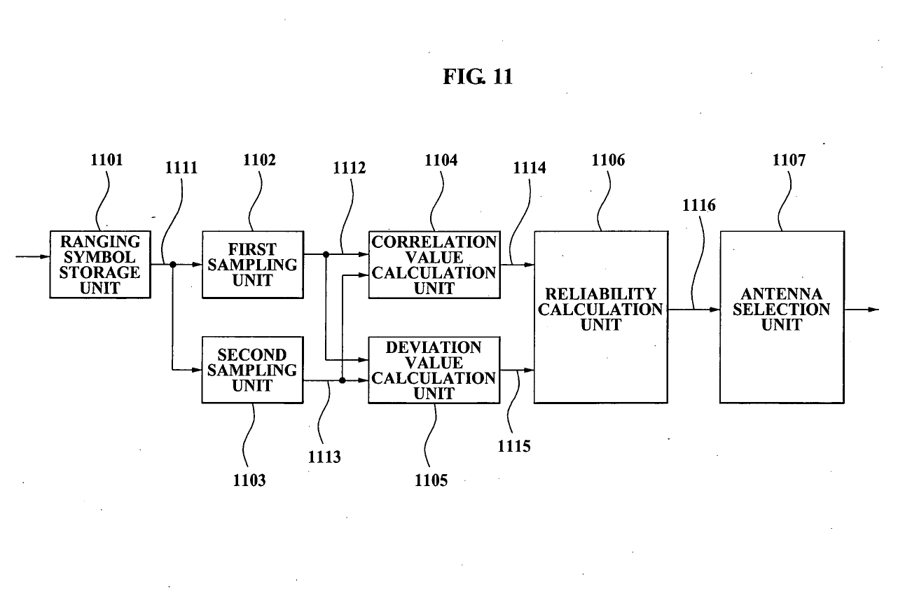

FIG. 11 is a block diagram illustrating an internal configuration of an antenna selection apparatus according to an embodiment of the present invention. Referring to FIG. 11, the antenna selection apparatus includes a ranging symbol storage unit 1101, a first sampling unit 1102, a second sampling unit 1103, a correlation value calculation unit 1104, a deviation value calculation unit 1105, a reliability calculation unit 1106, and an antenna selection unit 1107. Herein, each of the first sampling unit 1102 and the second sampling unit 1103 may be a separate module. However, the first sampling unit 1102 and the second sampling unit 1103 may be a sampling unit comprised of a single module.

The ranging symbol storage unit 1101 stores a time domain signal of a respective ranging symbol received from a plurality of antennas. For example, the ranging symbol storage unit 1101 forming the antenna selection apparatus may receive at least one ranging symbol with respect to each of the plurality of antennas and may store a time domain signal of the respective received ranging symbol. Also, a first sample signal 1112 and a second sample signal 1113 may be sampled from a stored ranging symbol 1111 received and stored after an initially received ranging symbol.

The first sampling unit 1102 and the second sampling unit 1103 sample the first sample signal 1112 and the second sample signal 1113 from a stored ranging symbol 1111, respectively. A number of samples of the first sample signal 1112 and the second sample signal 1113 is determined based on a length of a cyclic prefix interval included in the stored ranging symbol 1111. For example, the first sample signal 1112 and the second sample signal 1113 may include the cyclic prefix interval and a guard interval of the stored ranging symbol 1111, respectively. The first sample signal 1112 and the second sample signal 1113 may be sequentially or simultaneously sampled.

The correlation value calculation unit 1104 and the deviation value calculation unit 1105, shown in FIG. 11, calculate a correlation value 1114 and a deviation value 1115 of the first sample signal 1112 and the second sample signal 1113. The reliability calculation unit 1106 calculates a reliability value 1116 for antenna selection based on the correlation value 1114 and the deviation value 1115.

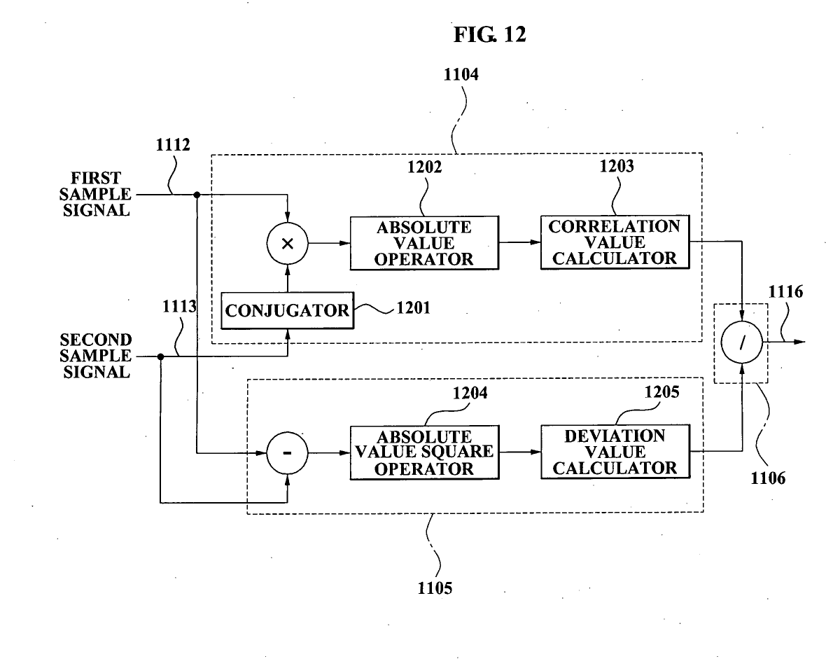

FIG. 12 is a block diagram illustrating internal configurations of the correlation value calculation unit 1104 and the deviation value calculation unit 1105 of FIG. 11.

Referring to FIG. 12, the correlation value calculation unit 1104 may include a conjugator 1201 calculating and outputting a complex conjugate of the second sample signal 1113, a multiplier multiplying the complex conjugate of the second sample signal 1113 and the first sample signal 1112 for each sample, an absolute value operator 1202 calculating an absolute value of a multiplication result for each sample, and a correlation value calculator 1203 cumulatively adding the absolute value of the multiplication result for each sample with respect to a predetermined correlation interval.

The deviation value calculation unit 1105 may include a subtracter calculating a difference between the first sample signal 1112 and the second sample signal 1113 for each sample, an absolute value square operator 1204 calculating a square of an absolute value of a subtraction result, and a deviation value calculator 1205 cumulatively adding the square of the absolute value of the calculated difference between samples with respect to the predetermined correlation interval.

As shown in FIG. 12, the reliability calculation unit 1106 of FIG. 11 may include a divider dividing the correlation value 1114 that is calculated by the correlation value calculation unit 1104 by the deviation value 1115 that is calculated by the deviation value calculation unit 1105.

As described above, the lengths of the first sample signal 1112 and the second sample signal 1113 and a length of the correlation interval in which the calculation result for each sample is cumulatively added by the correlation value calculator 1203 and the deviation value calculator 1205 may be determined based on the length of the cyclic prefix interval of the used ranging symbol, respectively.

The antenna selection unit 1107 selects an antenna corresponding to a maximum reliability value from a plurality of calculated reliability values 1116. As described above, according to another embodiment of the present invention, the antenna selection process may be performed by comparing the reliability value with a predetermined threshold value instead of the calculated maximum reliability value.

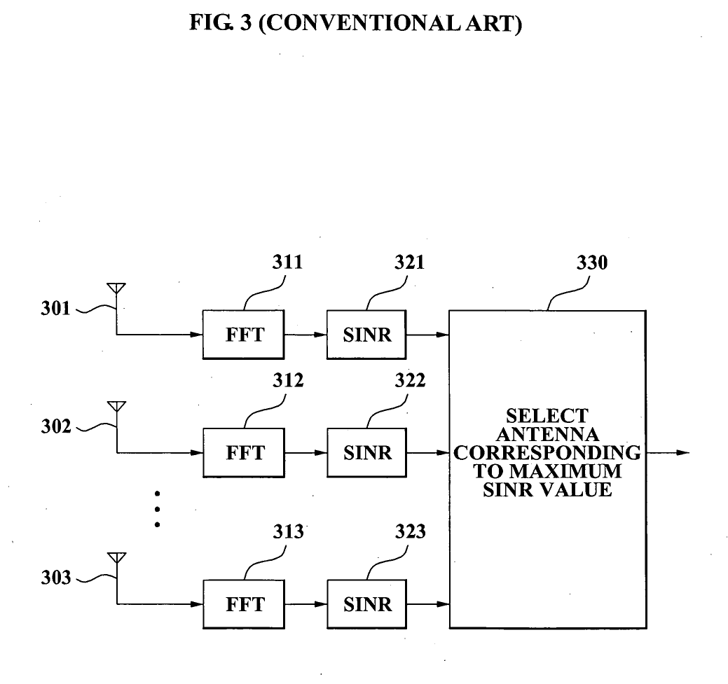

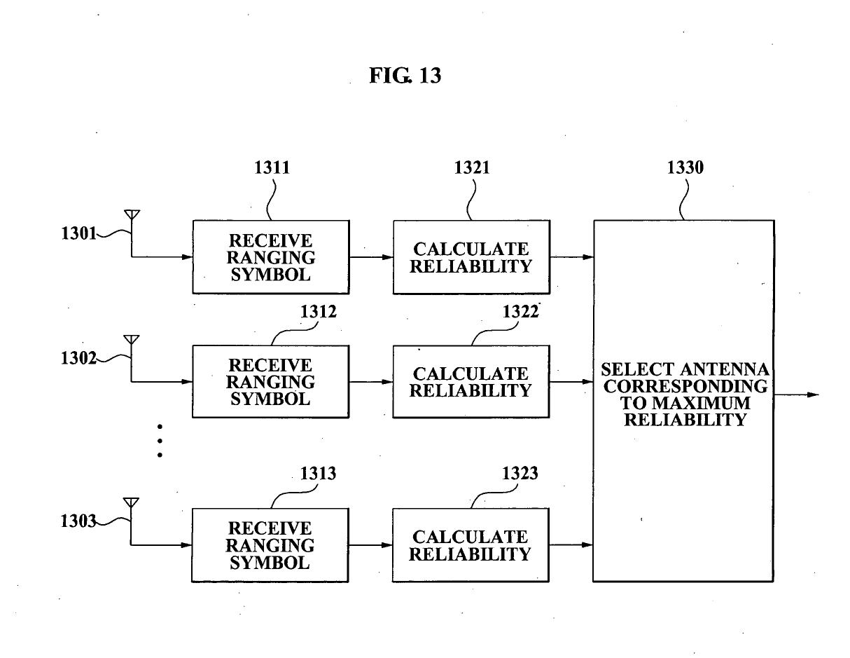

FIG. 13 is a block diagram illustrating, by comparing with FIG. 3, an operation/configuration of the antenna selection apparatus according to an embodiment of the present invention, with respect to a plurality of antennas. Referring to FIG. 13, the antenna selection apparatus receives a ranging symbol from a first antenna 1301 (1311) and calculates a reliability value of the first antenna 1301 by using the received ranging symbol (1321). The antenna selection apparatus selects an antenna corresponding to a maximum reliability value from a plurality of reliability values obtained by performing the reliability value calculation process with respect to the first antenna 1301, a second antenna 1302, and a third antenna 1303, namely, each of the plurality of antennas (1330).

The antenna selection apparatus of FIG. 13 includes a single reliability calculation unit 1321 performing calculation of a time domain signal, for each of the plurality of antennas.

The present invention is applied to antenna selection and ranging detection embodied by a base station system. As described above, a base station generally includes a plurality of antennas and transmits and receives a signal by using the plurality of antennas.

When receiving a ranging request from the plurality of antennas having a different channel delay spread, the base station has to first select an antenna to perform ranging detection of a relevant terminal.

Accordingly, the base station system according to the present invention may include a plurality of antennas for receiving a ranging symbol from a mobile communication terminal, an antenna selection apparatus selecting at least one antenna from the plurality of antennas based on correlation of a time domain signal of the respective ranging symbol received from the plurality of antennas, and a ranging detection apparatus detecting up-link ranging between the mobile communication terminal and the base station system by using the selected antenna.

The base station system according to the present invention may improve resource efficiency of an entire system when the ranging detection apparatus performing ranging detection using the antenna selected by the antenna selection apparatus uses a time domain calculation or a frequency domain calculation.

Namely, since the antenna selection apparatus included in the base station system according to the present invention performs a reliability value calculation by using the time domain signal, an additional hardware or software apparatus for an FFT and an inverse FFT is not used when the ranging detection apparatus using a result of the reliability value calculation is based on the time domain calculation.

Also, when the ranging detection apparatus is based on frequency domain calculation, since an FFT operator is not included with respect to the plurality of antennas and is only included with respect to the selected antenna, efficient use of hardware and software resources is improved.

Hitherto, since the antenna selection apparatus and the mobile communication base station system according to exemplary embodiments of the present invention have been described and the contents described with reference to the embodiments of FIGS. 4 through 10 may be applied to the present embodiment as is, hereinafter, detailed description of the same will be omitted.

According to an aspect of the present invention, there is provided a method of accurately selecting an optimal antenna in a multi-path fading channel environment based on a reliability value of an antenna obtained by a predetermined calculation method.

According to an aspect of the present invention, there is also provided an antenna selection method in which a reliability value is calculated by using a time domain signal of a received ranging symbol, thereby providing a simple and scalable antenna selection method.

According to an aspect of the present invention, there is also provided an antenna selection method in which a pilot symbol is not used in calculating a reliability value in a process compatible with IEEE802.16d/e and OFDM/OFDMA standards.

According to an aspect of the present invention, there is also provided an antenna selection method in which a cyclic prefix interval and a guard interval including a signal having the same pattern from a received ranging symbol are referred to, to accurately select an optimal antenna by sufficiently reflecting a channel feature.

According to an aspect of the present invention, there is also provided an antenna selection method in which a cyclic prefix interval and a guard interval of a ranging symbol received after an initially received ranging symbol from a plurality of received ranging symbols is sampled to prevent being affected by a distortion of the ranging signal due to multi-path fading, thereby accurately selecting the optimal antenna.

According to an aspect of the present invention, there is also provided an antenna selection apparatus in which it is not required to use FFT units for each of a plurality of antennas, thereby simplifying a configuration of the apparatus, reducing a manufacturing cost of the apparatus, and improving antenna selection speed.

According to an aspect of the present invention, there is also provided a base station system in which an optimal antenna for ranging detection is quickly and efficiently selected in response to a ranging request received from a plurality of mobile communication terminals, thereby providing the ranging detection with respect to the plurality of mobile communication terminals by using a small amount of time and cost.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of selecting an antenna for ranging detection in an orthogonal frequency division multiple access system, the method comprising:
receiving at least one ranging symbol from the antenna; and
determining whether to select the antenna, by computing a correlation of the received ranging symbol in a time domain.

2. The method of claim 1, wherein the determining whether to select the antenna comprises calculating a reliability value of the antenna,
the calculating a reliability value of the antenna comprising:
sampling a first sample signal and a second sample signal from the ranging symbol;
obtaining a correlation value by computing a correlation of the first sample signal and the second sample signal in a predetermined correlation length;
calculating a deviation value between the first sample signal and the second sample signal in the correlation length; and
calculating the reliability value by using the correlation value and the deviation value.

3. The method of claim 2, wherein lengths of the first sample signal and the second sample signal are determined based on a length of a cyclic prefix of the ranging symbol.

4. The method of claim 2, wherein the first sample signal and the second sample signal are included in the ranging symbol received after an initially received ranging symbol with respect to a timing of a frame including the ranging symbol.

5. The method of claim 2, wherein:
the first sample signal includes a cyclic prefix interval of the ranging symbol; and
the second sample signal includes a guard interval of the ranging symbol.

6. The method of claim 2, wherein the correlation length is determined based on a length of a cyclic prefix of the ranging symbol.

7. The method of claim 2, wherein the deviation value is calculated by accumulating a square of an absolute value of a difference between each sample of the first sample signal and the second sample signal, in the correlation length.

8. The method of claim 2, wherein the reliability value is calculated by an equation as follows:
$${Reliability}_{ant k} = \frac{\frac{1}{L} {\sum }_{i = 0}^{L - 1} \vert {r}_{1} ( i ) \cdot {r}_{2}^{*} ( i ) \vert}{\frac{1}{L} {\sum }_{i = 0}^{L - 1} {\vert {r}_{1} ( i ) - {r}_{2} ( i ) \vert}^{2}}$$
wherein:
Reliability_{ant k} indicates the reliability of a k-th antenna;
L indicates the correlation length;
r₁(i) indicates a signal value of an i-th sample from the first sample signal; and
r₂(i) indicates a signal value of an i-th sample from the second sample signal.

9. The method of claim 2, further comprising:
calculating reliability values with respect to each of a plurality of antennas; and
selecting an antenna corresponding to a maximum reliability value from the calculated reliability values.

10. The method of claim 1, wherein the determining whether to select the antenna is based on a strength of a time domain signal of the ranging symbol.

11. A computer readable recording medium in which a program for executing a method of selecting an antenna for ranging detection in an orthogonal frequency division multiple access system is recorded, the method comprising:
receiving at least one ranging symbol from the antenna; and
determining whether to select the antenna, by computing a correlation of the received ranging symbol in a time domain.

12. An apparatus for selecting an antenna for ranging detection in an orthogonal frequency division multiple access system, the apparatus comprising:
a ranging symbol storage unit storing a ranging symbol received in a time domain from each of a plurality of antennas;
a sampling unit sampling a first sample signal and a second sample signal from the stored ranging symbol;
a correlation value calculation unit calculating a correlation value between the first sample signal and the second sample signal;
a deviation value calculation unit calculating a deviation value between the first sample signal and the second sample signal;
a reliability calculation unit calculating a reliability value of the each of the plurality of antennas by using the correlation value and the deviation value calculated for the each of the plurality of antennas; and
an antenna selection unit selecting the antenna corresponding to a maximum reliability value from the calculated reliability values.

13. The apparatus of claim 12, wherein:
the ranging symbol storage unit receives and stores at least one ranging symbol from the each of the plurality of antennas; and
the first sample signal and the second sample signal are sampled from a ranging symbol sampled and stored after an initially received ranging symbol.

14. A mobile communication base station system using an orthogonal frequency division multiple access comprising:
a plurality of antennas for receiving a ranging symbol from a mobile communication terminal; and
an antenna selection apparatus selecting at least one antenna from the plurality of antennas based on correlation computing of the ranging symbol received in a time domain from each of the plurality of antennas.
